(19) United States
(12) Patent Application Publication
(10) Pub. No.: US 2013/0121760 A1
(43) Pub. Date: May 16, 2013

(54) Expandable clamp with interlacing jaw heads

(71) Applicants: Deming Chen, Changzhou (CN); Haiyan Xue, Changzhou (CN)

(72) Inventors: Deming Chen, Changzhou (CN); Haiyan Xue, Changzhou (CN)

(21) Appl. No.: 13/296,294

(22) Filed: Nov. 15, 2011

(51) Int. Cl. F16B 2/04

(52) U.S. Cl. 403/362

(57) ABSTRACT

An expandable clamp having a first jaw and a second jaw each having a rear end pivotally linking together, and an elastic member urging the first and the second jaws in a closing position in which the first and the second jaws touch each other. The fist jaw further has a first shoulder inclining inward, on which two first jaw necks are formed, leaving a space therebetween. A first jaw head being formed on each first jaw neck extending outward. The second jaw has a second shoulder inclining inward, on which one second jaw neck is formed. A second jaw head is formed on the second jaw neck extending outward. In the closing position, the first jaw necks and jaw heads are interlacing with respect to the second jaw neck and jaw head.

### CROSS-REFERENCE TO RELATED APPLICATIONS

Not Applicable

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The invention relates to an expandable clamp with interlacing jaw heads for modular frame assembly, and more particularly, to the expandable clamp having a stronger structure or smaller volume.

2. Description of Related Art

Modular panel frame assembly system is widely used in applications as office partitions, display racks, and window supports. A typical conventional expandable clamp for modular panel frame assembly is taught in U.S. Pat. No. 4,907,388. The clamp has opposing jaws that are always separated from each other by a substantial space. The frame members have at least one longitudinal central slit which is able to be engaged the by expandable clamp.

All conventional expandable clamps have a pair of opposing jaws which are basically symmetrical and face a common problem: a largest width of the longitudinal central slit defined in a frame member is decided by a cross-sectional area of the frame member. A wide central slit will significantly decrease a strength of a small cross-sectional area frame member. However, for opposing symmetrical conventional jaw heads and jaw necks, a thickness thereof cannot be limitlessly decrease for sake of structure strength. The thickness must be great enough to withstand a bending force acting on the jaw necks by the central slit when the expandable clamp is expanded. As a result, conventional expandable clamps are only applicable on “thick” frame members. “Thin” frame members having a relatively small cross-sectional area cannot accommodate a central slit wide enough to insert a conventional expandable clamp with a jaw neck having enough strength. Even for the frame members big enough for a conventional expandable clamp, the most vulnerable part of the clamp is still the jaw neck since a thickness thereof must be smaller than a half of the width of the central slit but always under a great bending force form the central slit when expanded.

### BRIEF SUMMARY OF THE INVENTION

The main object of the invention is to provide an expandable clamp with interlacing jaw heads which has a stronger jaw neck without requiring a wider central slit of a frame member.

Another object of the invention is to provide an expandable clamp with interlacing jaw heads having a small volume with jaw necks strong enough for small cross-sectional area frame members.

In order to accomplish the above objects, the present invention provides an expandable clamp having a first jaw and a second jaw each having a rear end pivotally linking together. The first jaw has a first inner face facing the second jaw and an opposing first outer face, and the second jaw has a second inner face facing the first jaw and an opposing second outer face. An elastic member urging the first and the second jaws in a closing position in which the first and the second jaws touch each other. The fist jaw further has a first shoulder inclining inward, on which two first jaw necks are formed, leaving a space therebetween. A first jaw head being formed on each first jaw neck extending outward. The second jaw has a second shoulder inclining inward, on which one second jaw neck is formed. A second jaw head is formed on the second jaw neck extending outward. A screw hole is defined in the second jaw. A set screw is engagable in the screw hole. In the closing position, the first jaw necks and jaw heads are interlacing with respect to the second jaw neck and jaw head, in which the second jaw neck and jaw head stay in the space respectively between the two first jaw necks and the two first jaw heads.

Comparing with conventional symmetrical jaw expandable clamps, the jaw necks of the invention do not have to be less than a half of the slit in the frame member but has a thickness of near a whole width of the slit. A strength of the jaw necks is significantly enhanced therefore for a slit of conventional size the expandable clamp of the invention is stronger and for situation requiring a conventional strength the expandable clamp can be made small in volume which is suitable for small cross-sectional area frame members.

These and other objectives, features, and advantages of the present invention will become apparent from the following detailed description, the accompanying drawings, and the appended claims.

### BRIEF DESCRIPTION OF THE SEVERAL VIEWS OF THE DRAWINGS

FIG. 1 is a side plane view of a frame member.

FIG. 2 is a side plane view of the preferred embodiment of the expandable clamp of the invention linking two frame members and being in a closing position.

FIG. 3 is another side plane view thereof linking the two frame members and being in an expanding position.

FIG. 4 is a perspective schematic view thereof in the expanding position.

FIG. 5 is a perspective schematic view thereof in the closing position.

FIG. 6 is a perspective schematic view of a first jaw thereof.

FIG. 7 is a perspective schematic view of a second jaw thereof.

FIG. 8 is a top plane view of the first jaw thereof.

FIG. 9 is a top plane view of the second jaw thereof.

FIG. 10 is a perspective view of a compressible bar thereof. And,

FIG. 11 is a perspective view of a set screw thereof.

### DETAILED DESCRIPTION OF THE INVENTION

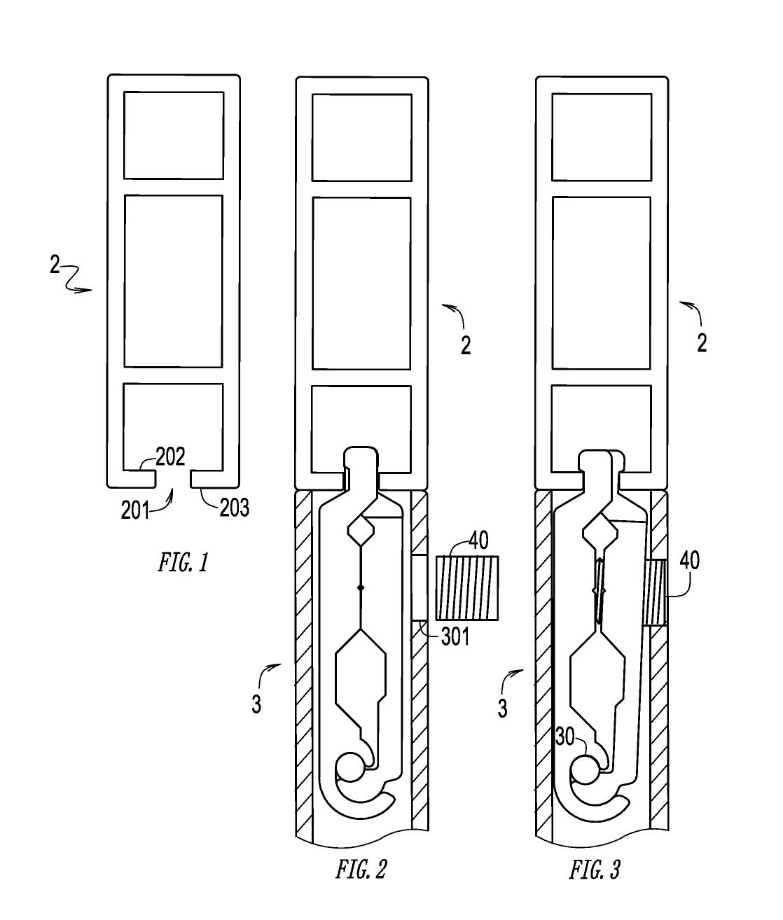

Shown in FIG. 1 is the preferred embodiment of an expandable clamp 1 of the invention linking a first frame member 2 and a second frame member 3. The first frame member 2 has at least one slit 201 defined therein, forming two opposing flange 202 and 203. The expandable clamp 1 is contained in the second frame member 3 and longitudinally fixed with respect to the second frame member 3 with a set screw 40.

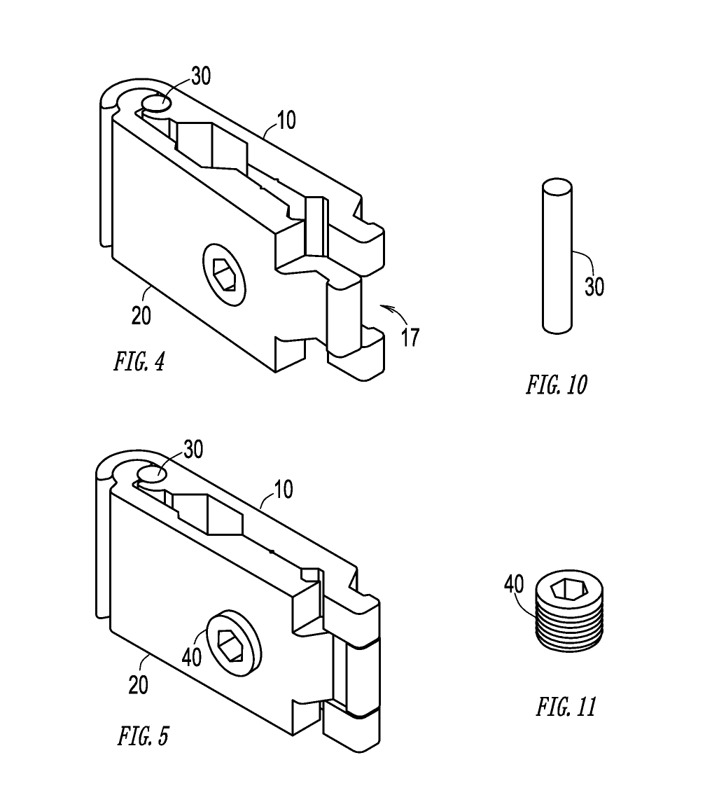

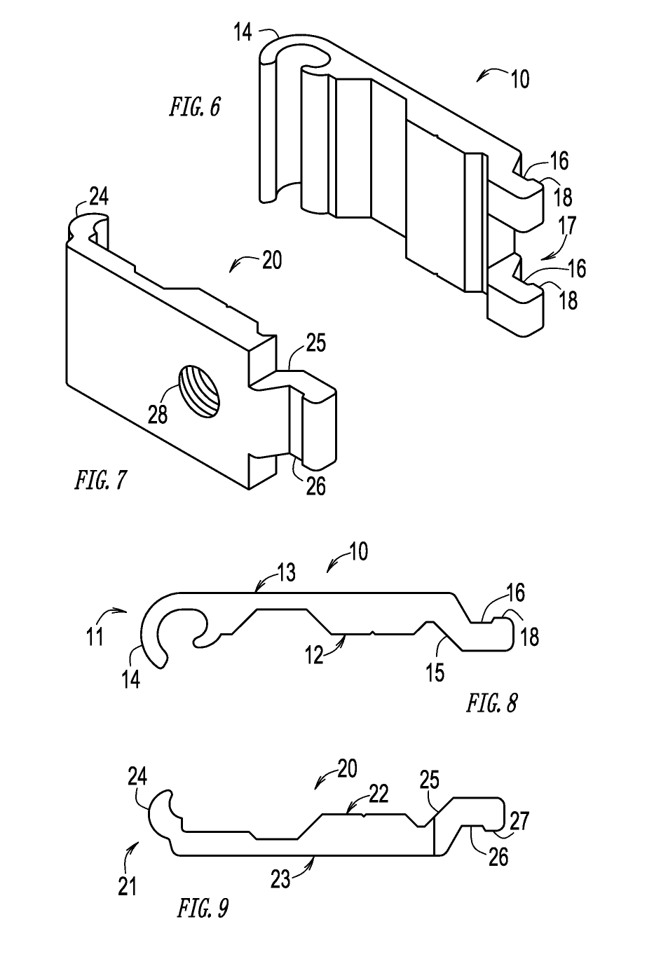

With reference to FIGS. 3 to 8, the expandable clamp 1 has a first jaw 10 and a second jaw 20 each has a rear end 11 and 21 pivotally linking together. The first jaw 10 has a first inner face 12 facing the second jaw 20 and an opposing first outer face 13. The second jaw 20 has a second inner face 22 facing the first jaw 10 and an opposing second outer face 23. The linking of the rear ends 11 and 21 is a conventional techniques and able to be any way that is pivotal. Shown in the Figs. is a usually way that is called quick assembly coupling in which one rear end 21 is a half round tail 24 and another rear end 11 is a half tube 14 being able to rotatably contain the half round tail 22. A compressible bar 30 is able to be inserted between the half round tail 22 and the half tube 12, urging the first and the second jaws 10 and 20 in a closing position in which the first and the second jaws 10 and 20 touch each other, as particularly shown in FIGS. 1 and 4.

The fist jaw 10 has a first shoulder 15 inclining inward, on which two first jaw necks 16 are formed, leaving a space 17 therebetween. One first jaw head 18 is formed on each first jaw neck 16 extending outward. The second jaw 20 has a second shoulder 25 inclining inward, on which one second jaw neck 26 is formed. A second jaw head 27 is formed on the second jaw neck 26 extending outward. The set screw 40 threadingly passes though a screw hole 28 defined in the second jaw 20. As particularly shown in FIGS. 1 and 4, when the expandable clamp 1 is in the closing position, the first jaw necks and jaw heads 16 and 18 are interlacing with respect to the second jaw neck and jaw head 26 and 27, in which the second jaw neck and jaw head 26 and 27 stay in the space 17 respectively between the two first jaw necks 16 and the two first jaw heads 18.

In use, as shown in FIGS. 1 and 2, the expandable clamp is able to be inserted in the second frame member 3 and then the set screw 40 is rotated into the screw hole 28 through an opening 301 defined in the second frame member 3. The expandable clamp 1 is longitudinally fixed with respect to the second frame member 3 by the set screw 40. Then the interlacing jaw heads 18, 27 is inserted in the slit 201 in the first frame member 2. Keep rotating the set screw 40, it will meet and push the first inner face 12 and the first jaw 10 and the second jaw 20 expand, as shown in FIG. 3. In the position of expanding, the jaw heads 18 and 27 engage with the opposing flange 202 and 203 and the expanding clamp 1 will firmly link the first and the second frame member 2 and 3 together. A reverse operation will be able to release the first and the second frame member 2 and 3.

From above description, it is seen that the objects of the present invention have been fully and effectively accomplished. Embodiment of the invention has been shown and described for the purposes of illustrating the functional and structural principles of the present invention and is subject to change without departure from the invention's principles. Therefore, this invention includes all modifications encompassed within the spirit and scope of the following claims.

1. An expandable clamp comprising:
a first jaw and a second jaw each having a rear end pivotally linking together, the first jaw having a first inner face facing the second jaw and an opposing first outer face, the second jaw having a second inner face facing the first jaw and an opposing second outer face, an elastic member urging the first and the second jaws in a closing position in which the first and the second jaws touch each other, the first jaw further having a first shoulder inclining inward, on which two first jaw necks are formed, leaving a space therebetween, a first jaw head being formed on each first jaw neck extending outward; the second jaw having a second shoulder inclining inward, on which one second jaw neck is formed, a second jaw head being formed on the second jaw neck extending outward, a screw hole being defined in the second jaw, and a set screw engagable in the screw hole, wherein in the closing position, the first jaw necks and jaw heads are interlacing with respect to the second jaw neck and jaw head, in which the second jaw neck and jaw head stay in the space respectively between the two first jaw necks and the two first jaw heads.

2. The expandable clamp as claimed in claim 1, wherein one rear end is a half round tail and another rear end is a half tube being able to rotatably contain the half round tail.
